(19) United States
(12) Patent Application Publication
(10) Pub. No.: US 2016/0257061 A1
(43) Pub. Date: Sep. 8, 2016

(54) EMBOSSING ROLLER

(71) Applicant: KONRAD HORNSCHUCH AG, Weißbach (DE)

(72) Inventors: Thorsten NEUMANN, Kupferzell (DE); Elena BERGER, Öhringen (DE); Klaus MOGLER, Ingelfingen (DE)

(21) Appl. No.: 15/030,334

(22) PCT Filed: Oct. 14, 2014
(86) PCT No.: PCT/EP2014/072039

§ 371 Date: Apr. 18, 2016

(30) Foreign Application Priority Data
Oct. 18, 2013 (DE) 10 2013 017 300.0

(51) Int. Cl. B29C 59/04; B29C 41/04

(52) U.S. Cl. CPC B29C 59/04; B29C 41/042; B29L 2031/757

(57) ABSTRACT

An embossing roller, including an inner hollow chamber, to which a vacuum can be applied, and a wall, which surrounds the hollow chamber and which has a structured surface, which includes elevations and recesses and which includes pores that communicate with the inner hollow chamber, wherein the wall includes a plurality of discrete and successive layers following one another from the hollow chamber in the direction of the surface and wherein the individual layers are based on epoxy-resin mixtures filled with fillers and comprise capillaries that communicate with each other and cavities for forming the pores.

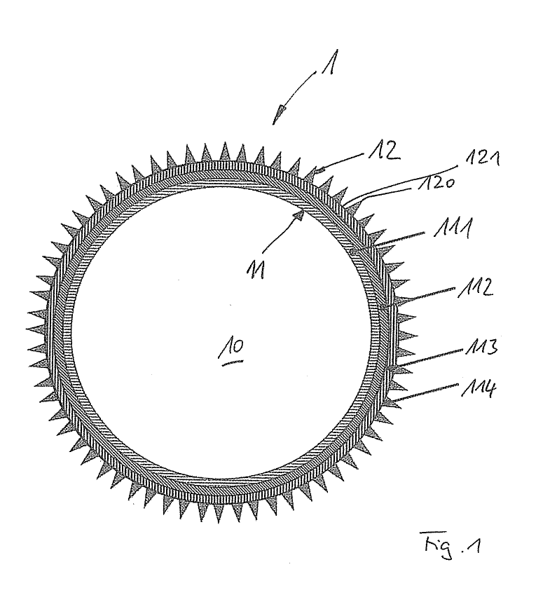

### BACKGROUND OF THE INVENTION

1. Field of the Invention

This invention relates to an embossing roller including an inner hollow chamber to which a vacuum can be applied, and a wall which surrounds the hollow chamber and which has a structured surface that includes raised areas and recesses and pores that communicate with the inner hollow chamber.

2. Discussion of Related Art

Embossing rollers of this type are known and are used, for example, in connection with the production of structured substrates such as imitation leather that have a surface that feels like the natural grain of leather. During or after their production, the substrates are guided over the surface of the embossing roller and with the vacuum that can be applied to the inner hollow chamber of the roller, which vacuum acts on the substrate via the pores, are drawn or sucked against the structured surface, whereupon the structured surface of the embossing roller is transferred in the reversal process to the surface of the substrate in which it is in contact.

Consequently, if the structured surface of the embossing roller forms, for example, a negative image of a leather grain, with corresponding raised areas and recesses, then this produces the exact reverse of this structured surface on the surface of the substrate, such as at the points in which the embossing roller has a raised area, a corresponding recess is produced in the substrate and vice versa. This method is therefore frequently also referred to as the vacuum or negative pressure embossing method.

The embossing rollers used for the above-described method can, for example, be made of metallic materials, and it is possible to produce the characteristic surface structure, such as with material-removing methods or by etching and the like. This is very complex and cost-intensive, and the pores that are required for transmitting the vacuum to the substrate must be mechanically produced in the wall in a labor-intensive fashion.

U.S. Pat. No. 3,072,961 A describes an embossing roller with a hollow chamber, a fibrous material mounted on it with an adhesive, which carries the embossing pattern, and an impregnation based on a filler-containing epoxy resin that is applied to the surface of the material. In this prior art as well, holes must be mechanically produced in the wall in a labor-intensive fashion.

### SUMMARY OF THE INVENTION

One object of this invention is to provide an embodiment of an embossing roller which should be efficient and economical to produce.

In order to attain the stated and other objects, this invention embodies an embossing roller according to the features of embodiments and modifications of this invention as described in this specification and in the claims.

One proposal according to this invention includes a wall of the embossing roller according to this invention including a plurality of discrete and successive layers one after the other from the hollow chamber in the direction toward the surface and the individual layers are made on the basis of epoxy-resin mixtures filled with fillers.

The multilayered embodiment of the wall proposed according to this invention, with epoxy-resin mixtures filled with fillers, makes it possible with a low consumption of raw materials, to form a wall that is sufficient to meet the mechanical demands of such an embossing roller, in whose outermost layer closest to the surface, such as the one that forms the surface of the embossing roller, the desired surface structure can be directly produced, such as by being formed during its manufacture.

Furthermore, the wall of the embossing roller thus produced automatically has pores that permit the vacuum to be transmitted from the hollow chamber to a substrate lying in the vicinity of or near the surface of the embossing roller. The effect that results in this pore formation is not fully explained, but it is believed that within the individual layers at the grain boundaries between the individual filler particles and the epoxy resin, capillaries and extremely small cavities form, which communicate with one another and together, form the pores.

For example, as the outermost layer is being formed out of the epoxy resin compound provided with fillers, it is possible to mold the surface structure through contact with a corresponding matrix.

It is also possible to produce the embossing roller according to this invention using the so-called centrifugal casting method in which a rotationally symmetrical permanent mold, whose inside has the surface structure to be molded, is set into rotation about its central axis and the filler-containing epoxy resin compound provided to form the layers according to this invention is placed against the wall of the permanent mold using an appropriate temperature level, causing the layers to form and also causing the outermost layer in the region of its surface to be molded with the negative of the surface structure of the permanent mold that is to be molded into it.

It is clear that thus forming an embossing roller in this way can occur in a particularly efficient way.

The surface structure to be produced by the embossing roller can, for example, be provided in the form of a metallic layer such as steel, a suitably temperature-resistant plastic layer such as silicone or fluorine-based plastic, or a natural layer such as a leather layer. In the case of the centrifugal casting method described above, the inner surface of the permanent mold is lined with this layer.

According to one embodiment of this invention, the outermost layer closest to the surface constitutes or forms the structured surface and has the raised areas and recesses, while the layers farther from the surface have respectively constant layer thicknesses.

The embossing roller embodied according to this invention is preferably rotationally symmetrical and cylindrically embodied, but can also have a slight convexity or conicity that deviates from the cylindrical form.

According to another embodiment of this invention, the layers each have a ratio of the epoxy resin mixture to the fillers of 1:15 to 2:1, preferably 1:10 to 1:1. The ratios can be selected by the person skilled in the art as a function of the desired properties of the layers. For example, in order to achieve higher mechanical strengths and higher wear resistance, a correspondingly higher filler content is selected.

According to one embodiment of this invention, the fillers of the layers of the embossing roller according to this invention are selected from the group including metal/nonmetal nitrides, -oxides, and/or -carbides. They can, for example, include silica sand, silicon carbide, aluminum oxide, boron nitride, and/or iron oxide(s), and carbon compounds such as graphite and diamond, as well as small percentages of metal powders such as copper, silver, or gold.

In addition, the fillers of the outermost layer closest to the surface can also include sodium chloride, sodium acetates, and/or potassium acetates and the fillers of the layer adjacent to the outermost layer closest to the surface can also include salts such as sodium chloride.

The fillers used are characterized by a good thermal conductivity, high hardness, and chemical resistance and promote the formation of capillaries and cavities that are essential for the use of the embossing roller in the vacuum embossing method.

In this case, the material that is to be embossed is usually brought to its softening temperature, guided across the embossing roller, and with the applied vacuum, pressed against the embossing surface, such as the layer closest to the surface. Due to the high thermal conductivity of the embossing roller that is promoted by the fillers, the structure is then frozen in that the film in the deformed state is cooled to below its softening temperature while it is resting on the embossing roller, such as the heat dissipation is carried out by the embossing roller according to this invention.

According to another embodiment of this invention, the fillers have a particle diameter of from 0.5 to 1000 μm.

In one embodiment of the embossing roller according to this invention, it has three other layers starting from an outermost layer closest to the surface of which the innermost layer has a higher mechanical strength than the remaining layers so that this innermost layer lends the embossing roller of this invention the required mechanical stability.

Naturally, the person skilled in the art can also embody the number of the layers differently if needs correspondingly dictate otherwise, such as it can be embodied with more or less than the four layers mentioned above.

This invention also relates to a method for producing an embossing roller of this type.

According to this invention, the embossing roller is produced by a sequence of the following steps: preparation of a rotationally symmetrical permanent mold, whose inside has the surface structure to be molded; preparation of a powdered fraction for forming the layer closest to the surface and introduction thereof into the permanent mold; setting of the permanent mold into rotation about its central axis and heating thereof to a temperature suitable for layer formation; formation of the layer closest to the surface and molding of the to-be-molded surface structure of the permanent mold in the region of its surface; and preparation of the powdered fractions for forming the other layers and introduction thereof into the permanent mold provided with the layer closest to the surface and successive repetition of the third mentioned step to form the other layers, hardening and cooling of the layer composite inside the permanent mold, which is kept in rotation, and subsequent removal of the embossing roller from the permanent mold.

The permanent mold in this case is heated to a raw material-dependent temperature to be selected by the person skilled in the art, preferably a temperature of 35 to 220° C.

According to one embodiment of this invention, after the fifth mentioned step, a ballast layer can be dispensed into the permanent mold that has been provided with the layers, before the hardening with rotation of and supply of heat to the permanent mold. The ballast layer can be composed of, for example, ballast sand, which can easily be removed again before the embossing roller is removed from the permanent mold.

The powdered fractions for forming the individual layers can be produced, for example, by mixing epoxy resin, hardener, and fillers with the addition of heat to produce a granulate and by subsequent milling and filtering. Powders of an average grain size of between 0.1 and 1000 μm are milled.

The hardening is carried out for a period of about 1 to 8 h, depending on the raw material selection and layer thickness of the embossing roller according to this invention.

### BRIEF DESCRIPTION OF THE DRAWING

One possible embodiment of this invention is shown in the drawing.

### DETAILED DESCRIPTION OF THE INVENTION

The sole FIGURE shows a cross-section through an embossing roller 1 with an inner hollow chamber 10, to which a vacuum can be applied in an intrinsically known fashion that is not shown in detail. Except for the line leading to the vacuum source (not shown), the ends of the embossing roller 1 are closed. The hollow chamber 10 is enclosed by a wall 11, which is cylindrically embodied in the exemplary embodiment shown and which includes a total of four discrete and successive layers 111, 112, 113, 114 one after the other from the hollow chamber 10 in the direction toward the cylindrical surface 12 of the embossing roller 1. All of the individual layers 111, 112, 113, 1.14 are comprised on the basis of epoxy resin mixtures filled with fillers and respectively bonded so that they adjoin one another.

The layers 111, 112, 113, 114 can have the same or different layer thicknesses.

The outermost layer 11 closest to the surface has a structured surface 12, including raised areas 120 and recesses 121, which simultaneously constitutes or forms the structured surface of the embossing roller 1. The raised areas 120 and recesses 121 can, for example, represent the negative image of a leather grain.

In addition, the wall 11 of the embossing roller 1 can have a multitude of pores that communicate with the inner hollow chamber 10, which extend through all of the 111, 112, 113, 114 to the surface 12 of the embossing roller 1, in order, by means of or with the applied vacuum in the hollow chamber 10, to provide a substrate (not shown), which is to be embossed and is guided across the embossing roller 1, with a positive embossing in accordance with the structured surface 12.

The pores in this case are composed of fine capillaries and cavities, which are contained in the individual layers 111, 112, 113, 114. To that end, the layers 111, 112, 113, 114 are respectively made of a mixture of epoxy resin and fillers and have a ratio of the epoxy resin mixture to the fillers of 1:15 to 2:1, preferably 1:10 to 1:1.

Possible fillers of the layers 111, 112, 113, 114 include, for example, silica sand, silicon carbide, iron oxide, aluminum oxide, calcium, magnesium oxide, and/or titanium oxide, and in addition, possible fillers of the outermost layer closest to the surface 114 also include sodium chloride, sodium acetates, and/or potassium acetates and possible fillers of the layer 113 adjacent to the outermost layer 114 closest to the surface also include salts such as sodium chloride.

The fillers used have a particle diameter of 0.5 to 1000 μm. During the formation of the individual layers 111, 112, 113, 114, capillaries and cavities that communicate with one another form along the grain boundaries of the fillers within the corresponding epoxy resin layers and these capillaries and cavities end up communicating with one another across all of the layers 111, 112, 113, 114, thus constituting or forming the pores 122.

The recipe of the innermost layer (111) is additionally selected so that it has a higher mechanical strength than the remaining layers (112, 113, 114).

With the above-explained embossing roller, it is in particular possible to mold two-dimensional or three-dimensional structures on sheet goods or web-shaped substrates, which are embodied as multilayered, such as imitation leathers based on polyurethane, hard- and soft PVC, polyolefins, and films based on polyolefins or PVC, for example, continuously by means of or with vacuum.

1. An embossing roller (1), comprising an inner hollow chamber (10) to which a vacuum can be applied, and a wall (11), which surrounds the hollow chamber (10) and which has a structured surface (12), which comprises raised areas (120) and recesses (121) and pores that communicate with the inner hollow chamber (10), the wall (11) comprising a plurality of discrete and successive layers (111, 112, 113, 114) one after the other from the hollow chamber (10) in a direction of the surface (12) and wherein the individual layers (111, 112, 113, 114) are made of epoxy-resin mixtures filled with fillers and comprise capillaries and cavities that communicate with one another to form the pores.

2. The embossing roller (1) according to claim 1, wherein the outermost layer (114) closest to the surface forms the structured surface (12) and has the raised areas (120) and the recesses (121), and the layers (113, 112, 111) farther from the surface have respectively constant layer thicknesses.

3. The embossing roller (1) according to claim 2, wherein the layers (111, 112, 113, 114) each has a ratio of an epoxy resin mixture to the fillers of 1:15 to 2:1.

4. The embossing roller (1) according to claim 3, wherein the fillers of the layers (111, 112, 113, 114) are selected from the group including metal- or nonmetal nitrides, -oxides, and/or -carbides and carbon compounds and metal powders.

5. The embossing roller (1) according to claim 4, wherein the fillers of the layers (111, 112, 113, 114) are selected from the group including silica sand, silicon carbide, iron oxide, aluminum oxide, calcium, magnesium oxide, and/or titanium oxide.

6. The embossing roller (1) according to claim 4, wherein the fillers of the outermost layer closest to the surface also include sodium chloride, sodium acetates, and/or potassium acetates.

7. The embossing roller (1) according to claim 5, wherein the fillers of the layer (113) that is adjacent to the outermost layer (114) closest to the surface (113) also include salts such as sodium chloride.

8. The embossing roller according to claim 6, wherein the fillers have a particle diameter of 0.5 to 1000 μm.

9. The embossing roller according to claim 7, wherein starting from an outermost layer closest to the surface (114), there are three other layers (113, 112, 111) of which the innermost layer (111) has a higher mechanical strength than the remaining layers (112, 113, 114).

10. A method for producing an embossing roller according to claim 1, including the following steps:
a) preparation of preparing a rotationally symmetrical permanent mold having an inside with the surface structure to be molded;
b) preparing a powdered fraction for forming the layer (114) closest to the surface and introduction thereof into the permanent mold;
c) setting the permanent mold into rotation about a central axis and heating to a temperature suitable for layer formation;
d) forming the layer (114) closest to the surface and molding the to-be-molded surface structure of the permanent mold near its surface;
e) preparing the powdered fractions for forming the other layers (113, 112, 111), introduction thereof into the permanent mold provided with the layer (114) closest to the surface, and successive repetition of step c) to form the other layers (113, 112, 111); and
f) hardening and cooling the layer composite inside the permanent mold, which is kept in rotation, and subsequent removal of the embossing roller from the permanent mold.

11. The method according to claim 10, wherein the permanent mold is heated to a temperature of 35 to 220° C.

12. The method according to claim 11, wherein after step e), a ballast layer is dispensed into the permanent mold having the layers (111, 112, 113, 114).

13. The method according to claim 12, wherein the powdered fractions for forming the individual layers (111, 112, 113, 114) are produced by mixing an epoxy resin, a hardener, and fillers with the addition of heat to produce a granulate and by subsequent milling and filtering.

14. A method for producing an embossing roller according to claim 9, including the following steps:
a) preparing a rotationally symmetrical permanent mold having an inside with the surface structure to be molded;
b) preparing a powdered fraction for forming the layer (114) closest to the surface and introduction thereof into the permanent mold;
c) setting the permanent mold into rotation about a central axis and heating to a temperature suitable for layer formation;
d) forming the layer (114) closest to the surface and molding the to-be-molded surface structure of the permanent mold near its surface;
e) preparing the powdered fractions for forming the other layers (113, 112, 111), introduction thereof into the permanent mold provided with the layer (114) closest to the surface, and successive repetition of step c) to form the other layers (113, 112, 111); and
f) hardening and cooling the layer composite inside the permanent mold, which is kept in rotation, and subsequent removal of the embossing roller from the permanent mold.

15. The method according to claim 10, wherein after step e), a ballast layer is dispensed into the permanent mold having the layers (111, 112, 113, 114).

16. The embossing roller (1) according to claim 1, wherein the layers (111, 112, 113, 114) each has a ratio of an epoxy resin mixture to the fillers of 1:15 to 2:1.

17. The embossing roller (1) according to claim 1, wherein the fillers of the layers (111, 112, 113, 114) are selected from the group including metal- or nonmetal nitrides, -oxides, and/or -carbides and carbon compounds and metal powders.

18. The embossing roller (1) according to claim 1, wherein the fillers of the layer (113) that is adjacent to the outermost layer (114) closest to the surface (113) also include salts such as sodium chloride.

19. The embossing roller according to claim 1, wherein the fillers have a particle diameter of 0.5 to 1000 μm.

20. The embossing roller according to claim 1, wherein starting from an outermost layer closest to the surface (114), there are three other layers (113, 112, 111) of which the innermost layer (111) has a higher mechanical strength than the remaining layers (112, 113, 114).
